(19) United States
(12) Patent Application Publication
(10) Pub. No.: US 2005/0038751 A1
(43) Pub. Date: Feb. 17, 2005

(54) System and method for software site licensing

(76) Inventor: Arthur Louis Gaetano JR., Chandler, AZ (US)

Correspondence Address: INTER-TEL, INC., 7300 WEST BOSTON STREET, CHANDLER, AZ, 85226, US

(21) Appl. No.: 10/641,853

(22) Filed: Aug. 15, 2003

(51) Int. Cl. G06F 17/60

(52) U.S. Cl. 705/59

(57) ABSTRACT

The software site licensing system includes a workstation that receives a license file from a license sales site and stores the license for uploading to a client site. The workstation connects to the client and transfers a copy of the license for validation. The client reviews the license and determines if the license is valid for its site and software application. Assuming the license is valid, the client indicates the same to the workstation and license is applied to the client as the current license. Additionally, the workstation generates a summary of proposed modifications that will result from the license being applied to the client. The summary can be viewed and approved by an installer to ensure the proper license is being installed. As new licenses are applied to the client, the older licenses are stored at the client for future reloading if needed.

### FIELD OF INVENTION

The present invention relates generally to software site licensing.

### BACKGROUND OF THE INVENTION

In a non-networked computer environment, it is a simple matter to enforce a software site license. Licensed software is installed on a single computer and each user's access to that computer is controlled by individual logins. The software is restricted to one machine and the number of logins is limited to a particular software application, thereby preventing unauthorized use that is not covered by the site license. As more processing systems gradually become networked together, thereby enabling a single software application to be “shared” over multiple computers, the issue of enforcing the software site license becomes increasingly problematic. Thus, controlling the legal distribution and use of licensed software is critical to prevent unauthorized software use or “piracy.”

Any unauthorized duplicating, browsing, or using of a software product or data constitutes software piracy. There are various categories of software piracy including; (i) “soft-lifting” or purchasing a single licensed copy of software and loading it onto several computers; (ii) making unauthorized copies of software available to end users through online downloading and uploading; (iii) illegally duplicating and selling software; and (iv) selling stand-alone software that was intended to be bundled with specific hardware. Although most computer users are aware that the unauthorized duplication and use of software is illegal, there is a general disregard for the importance of treating software as valuable intellectual property. Often times the legitimate owner of the software or data product knowingly permits the software to be duplicated onto multiple machines to avoid the extra cost of additional licensing fees or the time needed to obtain additional licenses, even if they are free. These act of software piracy are typically the most difficult to control.

The Internet provides increased connectivity for users worldwide but unfortunately at the cost of preserving software security. File sharing over the Internet is a common occurrence due to the elimination of physical as well as international software barriers. Even the software publishers that have proactively attempted to protect their software through site licenses, encryption, passcodes, and various other methods, were not fully prepared for the numerous hacking programs that compromise the software security and licensing mechanisms.

In spite of the potential of increased software piracy on the Internet, using the Internet as a legal vehicle for software distribution can be advantageous. Internet distribution of software from the licensor to the licensee altogether eliminates lost or damaged goods as well as late deliveries. Software vendors can electronically distribute software upgrades and additional components or modules, in conjunction with the original software license over the Internet and in higher volumes. For software recipients, Internet distribution means receiving the products faster and discounted by saving on media, shipping, labor, and storage costs.

There have been various attempts to enforce software site licenses in networked systems. One approach involves using a dedicated machine as a license server to generate software licenses to client machines. A client machine requests a license from the server which in turn validates the request and grants the license if validation is approved. For networks having a large number of users, these types of systems may simplify site license management due to the centralized control. However, because the licenses are stored in a single location, the server must always be in operation and functioning properly.

Another approach to enforce software site licensing includes software distributed on computer-readable media containing a serial number or some other special identifier that essentially provides a hardware/software match. When the software is installed on the machine, the unique identifier stored on the media is matched with the particular machine, thereby “unlocking” the software. If the software is moved to another machine, the licensee typically contacts the licensor again for permission to install the software on a different machine. This approach does not generally work well for software that is downloaded from a communication channel, such as the Internet, or otherwise mass distributed.

Another hardware/software approach involves a special piece of hardware called a “dongle” that is attached to the serial or parallel port of the computer. The software executing on the computer sends a random number to the dongle and the dongle performs a secret computation and returns a result. The software makes a like computation and if the two computations match the software continues to run. If the dongle fails or an additional feature is desired, the system is down until a new dongle can be physically obtained on site.

Still another approach is to distribute unprotected software on CDs, DVD, FTP file transfers, and Internet downloads and require the end user to purchase a license file from the licensor in order to run the software. The downloaded license file typically contains encrypted information that a software application decodes and uses to validate its installation and/or operation. In general, these techniques are used to make sure the license is valid, verify the software is licensed for this particular machine, and determine the level at which a software application is authorized to run. When software upgrades are installed, generally new licenses are also installed. The old license that corresponds to the prior version is typically erased and cannot be retrieved. Often times, installers are oblivious to the impact the upgrade and new license will have on the machine until after the license is installed, at which point it is too late to retrieve the old license to run the prior version. This results in customer complaints about wasted resources to manage licenses, inconvenient system upgrades, and difficulties in obtaining licenses for previous versions of software when upgrades have critical errors.

In spite of the efforts to combat software piracy, the previously described shortcomings prevail and piracy remains the primary cause of lost revenues within the software industry. Accordingly, an improved system and method for software site licensing is needed. Preferably, a controlled system for obtaining and managing site licenses for a real time software application is desired. It would be beneficial to utilize the speed and convenience of the Internet for software distribution without compromising security. Additionally, it is desirable to maintain previous licenses onsite for convenient site reactivation, if needed. Moreover, during system upgrades or the like, it would be advantageous to receive, as part of the normal installation, a summary of the proposed modifications to the system, machine or program which will result from installation of the license.

### SUMMARY OF THE INVENTION

A software site licensing system of the invention generally includes a license sales site for generating a software license that corresponds to a software site application, a programming workstation that receives the license, and a client site having the software site application. The client site validates the license against a plurality of predetermined conditions and provides the workstation with a report on whether the license is valid. A summary of proposed modifications which will result from applying the license to the client site appears on a display of the workstation, whereby an installer can view the summary and decide whether to complete the license application to the client site.

In one embodiment, the summary includes a comparison of features belonging to a then-current license and the license to be applied.

In another embodiment, the license is an electronic file transfer from the license sales site to the workstation.

In yet another embodiment, a software site license system includes a target site computer having a software site application, a license sales site generating and transmitting a software license corresponding to the software site application and the target site computer, a programming workstation receiving the software license from the sales site and uploading the license to the target, and a storage coupled to the target site having a plurality of licenses. The storage of licenses includes at least one previously uploaded license corresponding to a previous version of the software site application on the target. The previously uploaded license can be reloaded to the target without additional contact to the license sales site.

In still another embodiment, the target site computer selects the previously uploaded license transparent to a user upon reinstallation of the previous version of the software site application.

A method for uploading a software site license of the invention generally includes retrieving the license from a storage at a programming workstation, validating the license against one or more predetermined conditions, generating a summary of proposed modifications which would result from an upload of the license to the target computer, and receiving either an acceptance of the summary and saving a copy of the license at the target computer, or a rejection of the summary and indicating the upload failed.

In one embodiment, the validating occurs at the target computer, and in another particular embodiment, a replica of the license is provided to the target computer from the programming workstation for validating.

In yet another embodiment, the summary is generated at the programming workstation from a report received from the target computer as a result of the validation.

In still another embodiment, the acceptance is received from an installer after viewing the summary.

A process for reloading a previously uploaded software site license corresponding to a software application, according to the invention includes, executing a management application on a programming workstation, coupling the programming workstation to a target computer having the software application thereon, selecting the previously uploaded stored license from a plurality of stored licenses located at the target computer, and applying the previously uploaded license at the target computer as a current license.

In one embodiment, the coupling between the workstation and the target occurs over the Internet.

In another embodiment, the plurality of stored licenses includes a predetermined number of licenses and as a new license is added an older license is deleted.

In still another embodiment, a list of the licenses is updated to reflect the upload.

A method for software site licensing in accordance with embodiment of the invention includes, executing a management application on a programming workstation, connecting the programming workstation to a target computer having a software site application thereon, and retrieving a license file corresponding to the software application from a storage. The storage including a plurality of license files and at least one of the license files being previously uploaded on the target and corresponding to a previous version of the software site application and capable of reload to the target without additional contact to a license sales site. The method further includes generating a summary of proposed modifications which will result from applying the license as a current license at the target, and receiving a command to complete an application of the license and applying the license as the current license at the target.

In another embodiment, there is a dual command wherein a command is received from the target approving the license file, and a second command is received from an installer approving the summary of proposed modifications.

In yet another embodiment, a command is received to cancel the application of the license and an indication of the failed application is provided. Additionally, the software site application may be running on the target computer in an unlicensed state and an error message indicating the same is generated.

### BRIEF DESCRIPTION OF THE DRAWINGS

These and other features, aspects, and advantages of the present invention may be best understood by reference to the following description taken in conjunction with the accompanying drawings, wherein like reference numerals indicate similar elements:

FIG. 1 illustrates a software site license system in accordance with one embodiment of the invention;

FIG. 2 is an exemplary flow chart for uploading a license in accordance with an embodiment of the invention;

FIG. 3 is an exemplary flow chart for restoring a license in accordance with another embodiment of the invention; and

FIG. 4 is an exemplary display of the proposed modifications resulting from installation of a new license in accordance with one particular embodiment of the invention.

### DETAILED DESCRIPTION

The systems and methods of the invention are particularly useful in software site licensing of telecommunication software applications. As a result, the various aspects of the invention may be conveniently described with reference to the telecom industry. However, as will become apparent from the following disclosure, the invention is useful for site licensing of any software application.

In general, the invention provides an improved system and method for software site licensing. A license sales site delivers the software license to a programming workstation preferably via an electronic distribution channel, e.g., computer files over the Internet, however various other methods of distribution are within the scope of the invention. The programming workstation generally contains storage for the license file and a management application. The management application manages the received license as well as older licenses. In this manner, older versions of previously installed software licenses are retained and may be retrieved for convenient restoration, if needed. A connection between the programming workstation and a target computer is established to verify, upload and install the license. During installation, the management application provides the installer with a summary of the proposed modifications to the system, machine or program as a result of installing the license. Therefore, the installer can readily verify, prior to complete installation, that the to-be-installed license and the modifications to the system as a result of the license are exactly as purchased and/or intended. The target computer typically is used to control a site application (e.g., a telecommunications application providing a specialized service) and the license provides the clearance for the site application to run. Once the license is installed at the target computer, the presence of a valid local copy of the license enables the site application to continue operating, start operating, upgrade features, and so on.

A more detailed description of exemplary systems and methods for software site licensing in accordance with the invention will follow, to include a preferred embodiment and best mode.

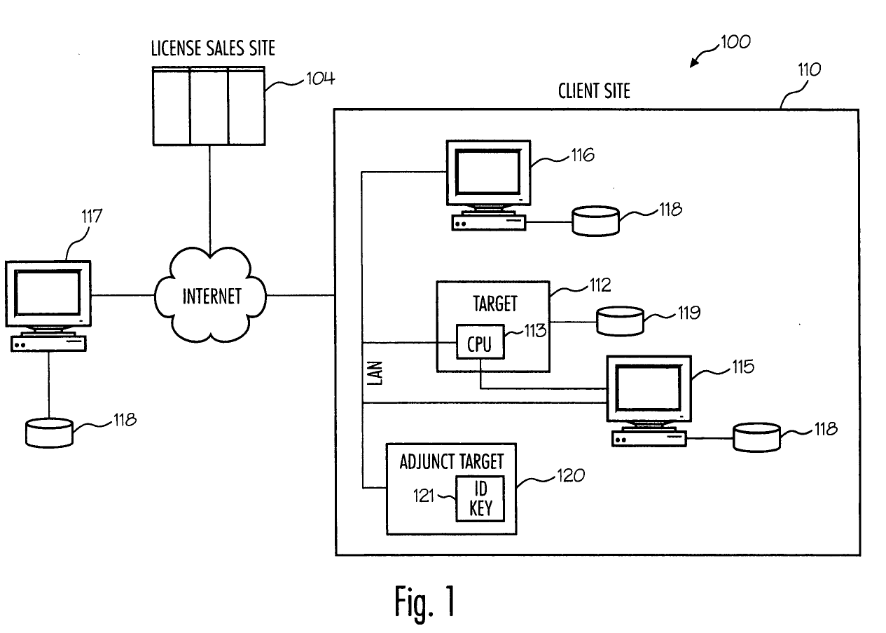

FIG. 1 illustrates a software site license system 100 in accordance with an embodiment of the present invention. System 100 generally includes a license sales site 104, a programming workstation 115-117, and a client site 110. License sales site 104 may include any suitable electronic/digital storage system capable of generating, storing and/or transmitting digitally produced files. In another sense, the license sales site may include (and be referred to herein as) a software license issuing entity having a license generating and storage facility containing the digital license files. In one particular embodiment, license sales site 104 represents a software vendor having one or more license computer files stored on a database for electronic distribution to client site 110.

Programming workstation 115-117 includes a storage 118 and may include any computing device capable of executing and storing software applications. Storage 118 includes any suitable storage means such as a disk-based database, memory, removable media, and/or data logging devices. It should be appreciated that programming workstation 115-117 may include multiple memory elements used for storing a variety of data and applications within the workstation. Additionally, it should be appreciated that storage 118 may include one or more storage elements capable of storing data immediately relevant to the invention as discussed herein, as well as various other data. Additionally, programming workstation 115-117 preferably includes a suitable input means (e.g., keyboard, touch screen, voice recognition, etc.) and a display. As will be discussed in more detail below, one aspect of the invention provides the license installer with a summary of the proposed modifications to the client site application as a result of the installation of the license. In one particular embodiment, the installer can view the summary on a display of the programming workstation.

Programming workstation 115-117 preferably includes at least one executable application referred herein as a “management application” installed and/or executed thereon. The management application may be a software application stored on the programming workstation, on a computer-readable media product, or available through a web-based application. In accordance with the various embodiments of license site system 100 of the invention, the management application assists the license installer in programming, management, connectivity, diagnostic, and verification of licenses, as well as various other site licensing functions as will be discussed herein. The management application may be executed on a programming workstation remotely from client site 110, such as programming workstation 117, or locally, such as programming workstation 115-116.

It should be realized that license site system 100 may include a single programming workstation 115-117 or a combination of local and/or remote programming workstations 115-117. In addition, one or more programming workstations 115-117 may include the management application or access to the management application. Thus, the installer may have access to the management application from one or several programming workstations.

License sales site 104 generates and issues valid licenses for client site 110. The generation of the licenses is beyond the scope of this invention and thus will not be discussed. However, for further reference to exemplary license generating systems and techniques, refer to U.S. patent application Ser. No. ______ filed on ______ by the same Applicant, the disclosure of which is incorporated herein by reference. The generated license is stored in license sales site 104 until transmitted to the client. Programming workstation 115-117 may establish a direct connection with license sales site 104 or through a web connection. The license transfer from sales site 104 to workstation 115-117 can occur via any number of techniques. For example, in one particular embodiment, the workstation receives a file transfer (download) representative of the license from the sales site. Alternatively, license sales site 104 may email the license file to programming workstation 115-117. In still another embodiment, the license file is delivered to programming workstation 115-117 on a computer-readable media product, such as CD, DVD, floppy disk, etc. The above examples of license-delivery are not intended to limit the scope of the invention in any way.

Client site 110 generally includes a target site or computer 112 and may include a programming workstation 115-116 as just described. Used herein, client site 110 also includes the entity benefiting from a software license issued from license sales site 104. Target computer 112 includes any suitable computing device and preferably includes a central processing unit (CPU) 113 or the equivalent and a storage 119. Storage 119 includes any suitable storage means such as a disk-based database, memory, removable media, and/or data logging devices. It should be appreciated that target 112 may include multiple memory elements used for storing a variety of data and applications within its processing subsystem. Additionally, it should be appreciated that storage 119 may include one or more storage elements capable of storing data immediately relevant to the invention as discussed herein, as well as various other data.

Target computer 112 controls a site application, meaning any software application that requires clearance from of a valid software license to run or execute its programs. Thus, as the name suggests, target computer 112 is the system in which the license from license sales site 104 is intended for. It should be realized that target computer 112 may include a single unit or comprise one or more units collectively referred to as target computer 112.

In one remote programming embodiment of the invention, programming workstation 117 establishes a connection with client site 110. The connection may be via the Internet or any other suitable communication channel, including wireless. Client site 110 typically includes a local area network (LAN) or an equivalent networking system within the site. In this sense, programming workstation 117 may communicate with client site 110, and more particularly with target computer 112, over, for example, an Internet path through a router/firewall that is coupled to a LAN at client site 110. Although not shown on FIG. 1, it should be appreciated that the connection from the LAN to target computer 112 may be through a TCP/IP link or the like. Alternatively, the connection between programming workstation 117 and target computer 112 may be partially or entirely via a wireless path. Once the connection between programming workstation 117 and target computer 112 is made, a file upload to target computer 112 can be done.

In one local programming embodiment of the invention, local programming workstation 116 establishes a connection with target computer 112. Any suitable connection technique or path may be used to facilitate routing between machines, such as the previously mentioned LAN and TCP/IP connection links. Once the connection between programming workstation 116 and target computer 112 is made, a file upload to target computer 112 can be done.

In another local programming embodiment of the invention, local programming workstation 115 is directly connected to target computer 112 and therefore no additional routing is required. This direct connection may be a wired or wireless connection and similar to the previous embodiments, a file upload from programming workstation 115 to target computer 112 can be made.

One particular embodiment of the invention includes an optional adjunct target processor 120. Adjunct target 120 communicates with target computer 112 in a master-slave manner, whereby adjunct target 120 is the master and target computer 112 is the slave. Adjunct target 120 stores or has access to the site application and therefore receives the uploaded license. An ID key 121 is attached to the target computer 112, the purpose of which is to make the target computer unique.

### EXEMPLARY FLOWCHARTS FOR SOFTWARE SITE LICENSING

The various operations of the present invention will now be discussed to further facilitate understanding of the invention and its best mode. It should be appreciated that the particular implementations shown and described are illustrative of embodiments of the invention (including its best mode) and are not intended to limit the scope of the present invention in any way.

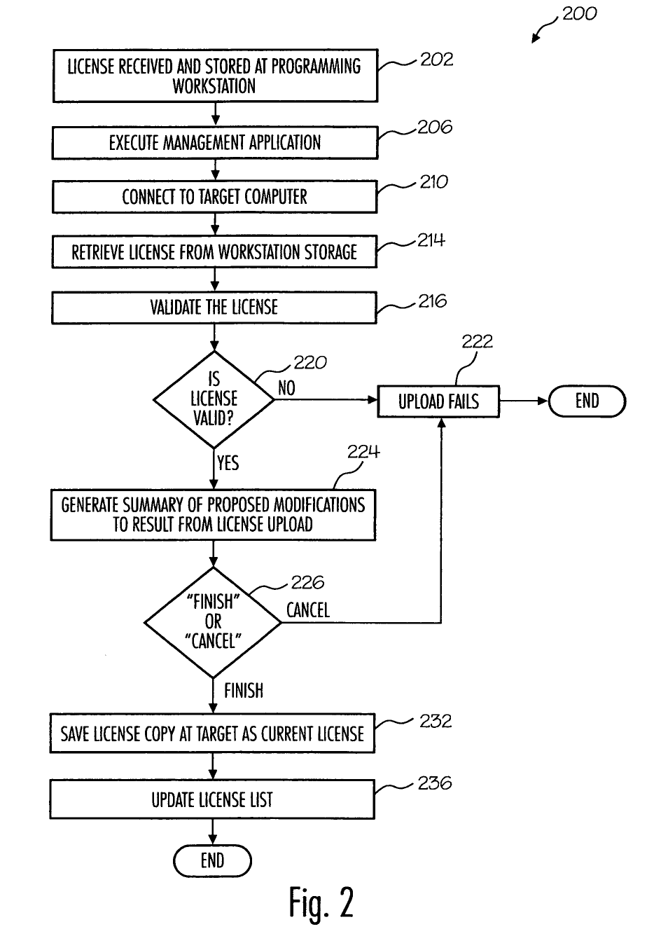

FIG. 2 is a flow chart of the operation of a software site licensing system (e.g., exemplary system 100) in accordance with one embodiment of the invention. In particular, flow chart 200 is an exemplary process for uploading a license from a programming workstation (e.g., programming workstation 115-117) to a target computer (e.g., target computer 112) in accordance with an embodiment of the invention. Initially, a valid license file is received from a licensor (e.g., license sales site 104) and stored in a memory of a programming workstation (step 202). Alternatively, the license file may be in a temporary storage such as may be customary with the use of a disk, CD, or DVD.

At the programming workstation, the installer initializes a management application loaded on the workstation (step 206). The management application facilitates the upload of the license file from the workstation to the target. The workstation connects to the target in a manner to permit file transfers (step 210). For example, the connection between the workstation and the target may be through an Internet web browser, LAN, TCP/IP link, direct connection, wired or wireless.

The installer may then be prompted to select the desired license file for uploading to the target. There are various methods in which the installer can select the specific file which are well known in the industry, such as a browsing function and file retrieval from a disk, or the like. Once the identified license file is selected, the file is retrieved from the workstation storage (step 214).

In one particular embodiment, the programming workstation provides the target with a replica of the license file. The target reviews the license and determines if this license is the appropriate license for this machine, application, etc. (i.e., license validation). The license file is validated against a variety of conditions present at the target and/or client site prior to uploading (step 216). In this sense, validation generally involves verifying that the license file is the correct license for this target and software application. There are numerous methods for validation of licenses which are well known in the industry and thus will not be discussed in detail herein. Often times, a list of conditions is matched against the license. The various conditions used to validate the license are generally determined by the licensor and/or the particular application the license is specified for. For instance, some exemplary conditions include; a hardware match, such as the serial number of the CPU processor of the target computer, a valid digital signature from the licensor, the number of permitted users, date and/or time license was generated, generated by an authorized license sales site, authorized for a particular target, license version, number of ports, whether the system can be part of a network, activation of accessories like messaging systems, and a check of the features granted by the license. It should be appreciated that the above conditions are not intended to be limiting in any way, and are provided merely as examples of commonly used verification conditions. The target then reports back to the programming workstation on whether or not the target can accept the license file.

After the verification is complete, the management application queries whether the target indicated that the license is valid (step 220). If there is a discrepancy in the verification process or if the license is not valid for the specified target, then the uploading process will fail (step 222). The installer may receive an error message indicating the upload failed, the license is invalid, or to contact the licensor. The error message may be a duplication of what the target reported to the programming workstation, or the management application may generate an appropriate error message. If, however, the license is determined to be valid, then the uploading process continues.

In accordance with one embodiment of the invention, the system generates a summary of proposed modifications which will result from completing the uploading process (step 224). The target may provide the programming workstation the modifications that will result from the license as part of the report sent to the workstation indicating that the license is valid. The summary may then be compiled by the management application from the data received from the target. In one sense, this feature provides an additional opportunity for verification of the license. For example, verification occurs when the system validates the license against a list of conditions as previously discussed (e.g., step 216) and another verification may occur as a result of the generation of a summary of proposed modifications. Additionally, the summary may be generated by the system and then reviewed and approved by the installer. In this manner, two kinds of verifications are possible, i.e., an automated or machine verification (e.g., steps 216-220) and a manual/human verification (e.g., steps 224-226).

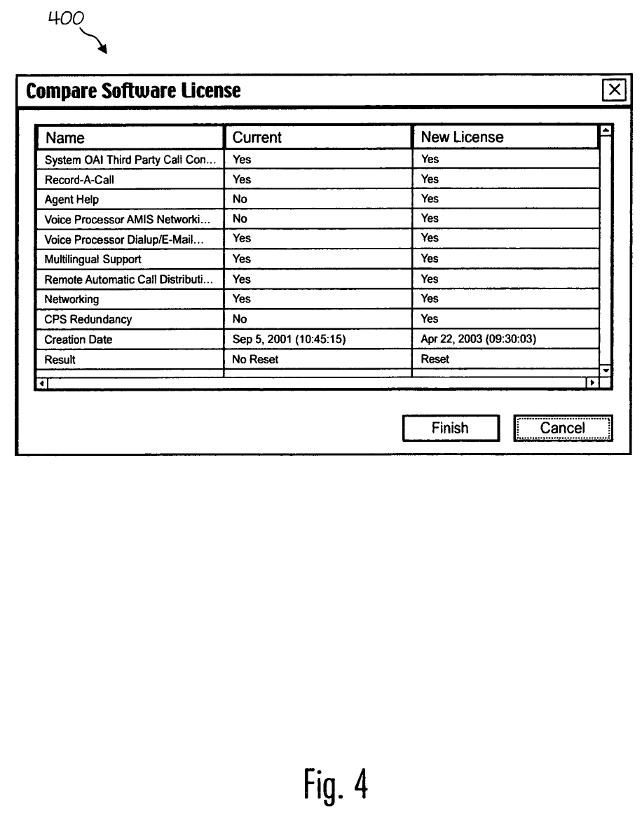

In one particular embodiment, the installer can review the summary by viewing the proposed modifications on a display of the workstation. With combined reference to FIGS. 2 and 4, an exemplary display 400 of the summary of proposed modifications is illustrated. In this example, a comparison of the current license features with the new license features is shown. At a glance, the installer can view the differences in features between the old and new licenses. This provides additional reassurances that the new license includes what was expected prior to completing the upload. Although illustrated as a comparison of current-to-new licenses, other embodiments of this feature may include summaries of the new license features only. Regardless of the technique used to provide the installer with the summary, the system may then prompt the installer to select “Finish” or “Cancel” the license upload as a result of reviewing the summary (step 226). If the cancel option is chosen, then the upload process will fail (step 222). If the installer approves the proposed modifications of the new license, then the finish option can be selected and the upload process will continue.

A copy of the license file is transmitted from the workstation to the target via the established connection. The transmission occurs after the installer has reviewed the summary and approves the proposed modifications; however, the license copy can be transmitted at an earlier point in the uploading process and held in a temporary storage of the target. For example, the programming workstation can transmit a copy of the license file to the target prior to the target validating the license. The target validates the license and replies back to the workstation with a report that the license is valid, or not, and what features the license contains. If the workstation is notified that a valid license has been sent to the target, then no further transmission of licenses is needed. If, however, the target reports that the license file received is invalid, for whatever reason, the target may delete the license file from its storage (temporary or permanent) and the process ends.

Once all verifications are complete, a copy of the license file is stored in the memory of the target computer (e.g., storage 119) as the “current” license (step 232). In one particular embodiment, the previous license is superseded and the uploaded license becomes the current license (e.g., when a new feature to the same application is added). In yet another embodiment, the previous license may be stored and the uploaded license becomes the current license (e.g., when a new version of the software application is uploaded). Stored licenses preferably remain on site at the target for future retrieval, if necessary. Alternatively, a previous software version and its applicable license may be completely reloaded. The target and/or the workstation preferably store a list of all the licenses available for the target, which may include the previously uploaded licenses. Once the current license is uploaded, this license list is updated to include the current license (step 236).

In one embodiment, the installer is able to view and edit the license list. For example, the installer may determine that one or more of the licenses listed will not be of future use and the installer selects to delete the license files from the target computer memory.

In another embodiment, the installer or system administrator is able to review details of the current license loaded on the target computer. The detailed review may include a listing of the features currently running under the license as well as suggested optional features available. This function is particularly useful in obtaining an inventory of currently installed systems and their capabilities and functions. The review may occur locally at the target computer or programming workstation, or remotely at a programming workstation.

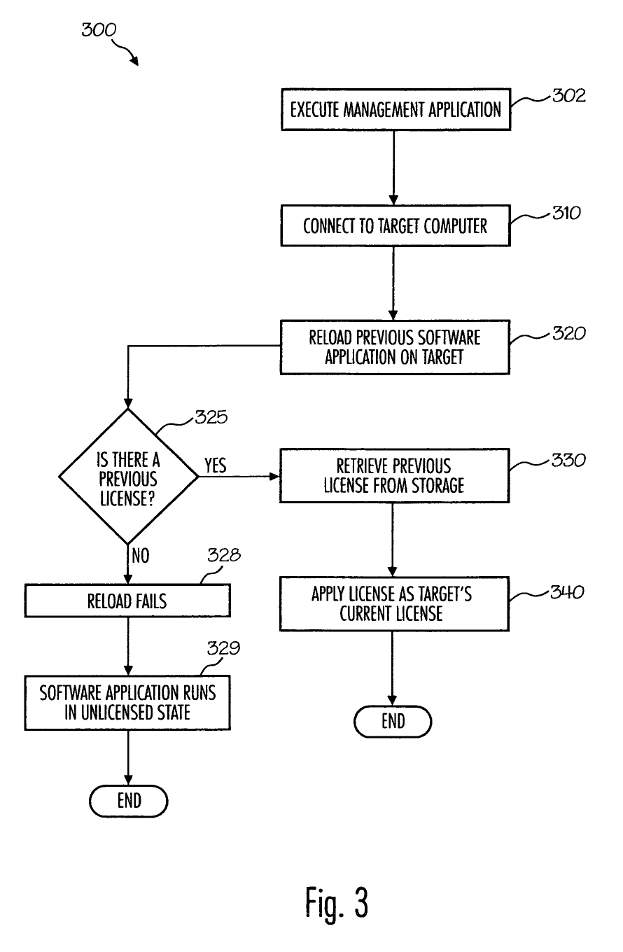

FIG. 3 is another flow chart of the operation of a software site licensing system (e.g., exemplary system 100) in accordance with another embodiment of the invention. In particular, flow chart 300 is an exemplary process for restoring a previous license from memory, in accordance with the invention. This is particularly useful when a new software application or upgrade has been installed along with the new license and the new application does not perform properly. The user may wish to simply go back to the previous software application until the developer corrects the errors in the new version. The restoring process begins by executing the management application either locally or remotely on a programming workstation (step 302). A connection between the target computer and the workstation is established in any of the previously described techniques or the like (step 310). These initial steps are similar to the previously described steps 206 and 210 and thus the details will not be repeated.

Often times, the previous version of a software application must be reloaded to the target because a newer version replaced it, or the application was deleted without a replacement (step 320). In one particular embodiment, the current software application is completely replaced with the reloaded software application, however the license corresponding to the current software is not replaced or deleted. Rather, the current license is stored in a memory, for example at the target or the workstation.

Once the reloaded software is fully installed, the system queries whether there is a previous license on file for this particular software (step 325). As previously mentioned, because the license files are preferably not deleted but are stored for future use, as long as the same software version that was previously loaded is being re-installed (or available for use), a license for that software application is already in place. The previous licenses may be stored in the workstation (e.g., storage 118) or preferably stored at the target (e.g., storage 119). If there is no license stored for that particular software or software application, or if the license cannot be validated for some reason, then the reload will fail (step 328). The installer may receive an error message indicating the reload failed, the license is invalid, or to contact the licensor. Additionally, the software application may continue/begin to run, however the application will run in an unlicensed state (step 329). The system may recognize the unlicensed software application and generate periodic error messages and/or reset the application.

If there is a previous license matching the reloaded or pre-installed software, then the license is retrieved from storage or memory (step 330). Preferably, the retrieval step occurs seamlessly without further input from the installer. In other words, the target computer and/or the software application may search out the storage for the corresponding license without interaction from the installer. However, there may be occasion when the installer is asked to accept the license prior to the retrieval. Optionally, similar to previously described steps 224-226, the system may generate a summary of the proposed modifications as a result of the reloaded license and prompt the installer to “cancel” or “finish” the reload. In this manner, the restoration process includes multiple verifications similar to the previously described uploading process (e.g., flow chart 200). The retrieved license is applied as the target's current license (step 340) and the restoration is complete.

In addition to the above process, the system or installer may update a license list with the just-restored license listed as the current license, or may delete unused or unwanted licenses.

In another embodiment of the invention, the system can include an automated process for deletion of older licenses. For example, the system may only store a select number of licenses (e.g., up to five) and as new licenses are uploaded, the oldest stored license is deleted. The stored licenses are available at the target for reload, if needed. In another example, the licenses may include a predetermined expiration date. Thus, the licenses will automatically expire at a certain future date. The installer/user may receive warning messages of the soon-to-expire license to allow the user ample time to renew the license with the licensor, if desired.

In the event of failure of a CPU, or the like, at the target computer, a switchover to a standby unit can be done. In one embodiment, a special license that has been designated for failover situations may be used. A backup CPU can take over operations by sharing a license with the failed master CPU. This allows the licensor to offer discounted pricing on special license packages for standby CPUs. The system provides license protection by tagging the backup CPU with a backup key that identifies it for backup use. During normal operations, with both master and backup systems in operation, the backup system copies the license data from the master. This allows the backup system to work indefinitely if the master fails. If there is a backup system designated as a master system at another site, the system may detect the attempted fraud and may not operate normally.

If a CPU or similar unit at the target needs to be replaced, the existing licenses may need to be transferred to a new CPU. The licensor can be contacted to obtain a new license that matches the new CPU, if this is a required condition for validation.

For the sake of brevity, conventional techniques for signal processing, data transmission, signaling, and network control, and other functional aspects of the systems (and components of the individual operating components of the systems) may not be described or illustrated in detail herein. Furthermore, the connecting lines shown in the various figures contained herein are intended to represent exemplary functional relationships between the various elements. It should be noted that many alternative or additional functional relationships and/or physical connections may be present in a practical telecommunications system.

Presented herein are various methods and techniques for monitoring and reporting the availability of resources, including the best mode. Having read this disclosure, one skilled in the industry may contemplate other similar techniques, modifications of structure, arrangements, proportions, elements, materials, and components for managing the availability of resources that fall within the scope of the present invention. These and other changes or modifications are intended to be included within the scope of the present invention, as expressed in the following claims.

1. A software site license system comprising:
a license sales site generating a software license that corresponds to a software site application;
a programming workstation having a display, said programming workstation receiving said license from said license sales site and providing said license to a client site;
the client site including said software site application, said client site validating said license against a plurality of conditions and providing said workstation with a report on whether said license is valid; and
a summary comprising a list of proposed modifications which would result from an upload of said license from said workstation to said client site, said summary appearing on said display of the workstation,
whereby, an installer is able to view said summary on said display and decide whether to complete said upload of said license to said client site.

2. The software site license system of claim 1, wherein said summary comprises a comparison of features belonging to a then-current license and said license to be uploaded.

3. The software site license system of claim 1, wherein said plurality of conditions comprises at least one of confirmation of a valid digital signature, authentication that said license was generated from said license sales site, authorized for said client site, and authorized for said software site application.

4. The software site license system of claim 1, wherein said client site receives a replica of said license for validating.

5. The software site license system of claim 1, wherein said programming workstation receives an electronic file transfer from said license sales site comprising said license.

6. A software site license system comprising:
a license sales site generating and transmitting a software license;
a target site computer having a software site application, said software license corresponding to said software site application and said target site computer;
a programming workstation receiving said software license from said sales site and uploading said license to said target; and
a storage coupled to said target site, said storage including a plurality of licenses received from said workstation, said plurality of licenses comprising at least one previously uploaded license corresponding to a previous version of said software site application on said target, and said previously uploaded license capable of reload to said target without additional contact with said license sales site.

7. The software site license system of claim 6, wherein said license sales site transmits an electronic file comprising said license to said programming workstation.

8. The software site license system of claim 6, wherein said target site computer selects from said storage said previously uploaded license corresponding to said previous version of said software site application, and the selection occurs transparent to a user upon reinstallation of said previous version of said software site application.

9. The software site license system of claim 6 further comprising a summary of proposed modifications which will result from a reload of said previously uploaded license.

10. The software site license system of claim 9, wherein said summary is displayed on a display of said programming workstation.

11. A method for uploading a software site license corresponding to a software application on a target computer, said method comprising;
retrieving said license from a storage at a programming workstation;
validating said license against one or more predetermined conditions;
generating a summary of proposed modifications which would result from an upload of said license to said target computer; and
receiving (i) an acceptance of said summary and saving a copy of said license at said target computer, or (ii) a rejection of said summary and indicating said upload failed.

12. The method for uploading a software site license of claim 11, wherein said validating occurs at said target computer.

13. The method for uploading a software site license of claim 11 further comprising providing a replica of said license from said programming workstation to said target computer for validating.

14. The method for uploading a software site license of claim 11, wherein said summary is generated at said programming workstation from a report received from said target computer as a result of said validation.

15. The method for uploading a software site license of claim 11, wherein said summary comprises a comparison of features between a then-current license and said license to be uploaded.

16. The method for uploading a software site license of claim 11 further comprising receiving at said programming workstation an electronic file transfer comprising said license from a license sales site.

17. The method for uploading a software site license of claim 11, wherein said acceptance is received from an installer after viewing said summary.

18. The method for uploading a software site license of claim 11, wherein said conditions comprise at least one of authentication that said license was generated by an authorized sales site, authorized for said target computer, and authorized for said software application.

19. A process for reloading a previously uploaded software site license corresponding to a software application, said process comprising;
executing a management application on a programming workstation;
coupling said programming workstation to a target computer having said software application thereon;
selecting said previously uploaded stored license from a plurality of stored licenses located at said target computer; and
applying said previously uploaded license at said target computer as a current license.

20. The process of claim 19, wherein said coupling occurs over the Internet.

21. The process of claim 19 further comprising generating a summary of proposed modifications which will result from applying said previously uploaded license at said target.

22. The process of claim 21, wherein said applying step occurs only after receiving an approval of said summary.

23. The process of claim 19, wherein said plurality of stored licenses comprises a predetermined number of licenses and as a new license is added an older license is deleted.

24. The process of claim 19, further comprising updating a list of said plurality of licenses to reflect the upload.

25. A method for software site licensing comprising:
executing a management application on a programming workstation;
connecting said programming workstation to a target computer having a software site application thereon;
retrieving a license file corresponding to said software application from a storage, said storage comprising a plurality of license files and at least one of said license files being previously uploaded on said target and corresponding to a previous version of said software site application and capable of reload to said target without additional contact to a license sales site;
generating a summary of proposed modifications which will result from applying said license as a current license at said target; and
receiving a command to complete an application of said license and applying said license as said current license at said target.

26. The method for software site licensing of claim 25, wherein said summary comprises a comparison of features between a then-current license and said retrieved license file.

27. The method for software site licensing of claim 25, wherein said connecting occurs over the Internet.

28. The method for software site licensing of claim 25, wherein said command is received from said target after performing a validation of said license.

29. The method for software site licensing of claim 25, wherein said command comprises a dual command wherein a command is received from said target approving said license file as said current license and a second command is received from an installer approving said summary of proposed modifications.

30. The method for software site licensing of claim 25 further comprising receiving a command to cancel the application of said license and indicating said application failed.

31. The method for software site licensing of claim 31 further comprising running said software site application on said target computer in an unlicensed state and generating an error message indicating the same.

32. The method for software site licensing of claim 25, wherein said storage is at said programming workstation and said license file comprising an electronic file transferred to said programming workstation from a license sales site.
